(19) United States
(12) Patent Application Publication
(10) Pub. No.: US 2015/0066543 A1
(43) Pub. Date: Mar. 5, 2015

(54) METHODS FOR FACILITATING A MOTOR VEHICLE INSURANCE EXCHANGE AND DEVICES THEREOF

(71) Applicant: Interactive Driving Systems, Inc., Cape May Court House, NJ (US)

(72) Inventor: Edmund S. Dubens, Cape May Court House, NJ (US)

(73) Assignee: Interactive Driving Systems, Inc., Cape May Court House, NJ (US)

(21) Appl. No.: 14/016,993

(22) Filed: Sep. 3, 2013

(51) Int. Cl. G06Q 40/08

(52) U.S. Cl. CPC G06Q 40/08
USPC 705/4

(57) ABSTRACT

A method, non-transitory computer readable medium, and an insurance exchange device that obtains at least historical risk event data and telematic data for at least one motor vehicle driver in response to a received request for an insurance underwriting offer for the motor vehicle driver(s). The at least one motor vehicle driver can be an individual driver, in which case the request can be received from a consumer customer, or a plurality of motor vehicle drivers, in which case the request can be received from a commercial customer representing a fleet of vehicles and associated drivers, for example. A performance profile is generated for the motor vehicle driver(s) based on the historical risk event data and telematic data. The performance profile is provided to motor vehicle insurance providers. An insurance underwriting offer is received from at least one of the insurance providers and sent in response to the request.

### FIELD

This technology generally relates to methods and devices for facilitating a motor vehicle insurance exchange and, more particularly, for providing prospective customers with insurance underwriting rates generated by insurance providers based on a comprehensive profile or motor vehicle driver data.

### BACKGROUND

Prospective customers, including motor vehicle drivers and fleet operators, generally initiate a request for motor vehicle insurance directly to an insurance provider. In order to receive many cost estimates from which to choose, the prospective customer must initiate a separate request to each of a plurality of insurance providers, which is inefficient. For example, each request often includes similar or corresponding parameters (e.g. demographic information and requested coverage options) which must be input and/or submitted by the prospective customer for each insurance provider.

Each insurance provider then requests permission from the prospective customer to obtain relevant motor vehicle record(s), such as from a state department of motor vehicles, for example. In the case of a fleet operator, insurance providers generally request access to motor vehicle records of a randomly selected subset of motor vehicle drivers associated with the fleet operator. With the motor vehicle records, the insurance provider determines the risk level of the associated driver(s) and generates an underwriting rate which is included in an offer sent to the prospective customer for consideration and acceptance.

While motor vehicle records provide insight regarding some historical risk events such as violations, they lack significant data that would otherwise be useful for insurance providers to adequately assess the risk of insuring the prospective customer. For example, telematic data, obtained by vehicle telematics devices, includes objective data regarding motor vehicle driver behavior. While insurance providers may have access to telematic data output by devices provided to their current customers, insurance providers are unable to obtain telematic data for prospective customers.

As another example, insurance claims data includes information regarding risk events, such as incidents and collisions, that also would be useful to insurance providers for determining an underwriting rate. Unfortunately, insurance providers are also unable to obtain such incident and collision data for prospective customers. Absent sufficient data regarding prospective customers, insurance providers face an increased risk of making imprudent underwriting decisions and/or generating offers with unfavorable rates.

### SUMMARY

A method facilitating a motor vehicle insurance exchange includes obtaining, with an insurance exchange device, at least historical risk event data and telematic data for a motor vehicle driver in response to a received request for an insurance underwriting offer for the motor vehicle driver. A performance profile is generated, with the insurance exchange device, for the motor vehicle driver based on the historical risk event data and telematic data. The performance profile is provided, with the insurance exchange device, to a plurality of motor vehicle insurance providers. An insurance underwriting offer is received, with the insurance exchange device, from at least one of the motor vehicle insurance providers. The insurance underwriting offer is sent, with the insurance exchange device, in response to the received request.

A non-transitory computer readable medium having stored thereon instructions facilitating a motor vehicle insurance exchange comprising machine executable code which when executed by a processor, causes the processor to perform steps including obtaining at least historical risk event data and telematic data for a motor vehicle driver in response to a received request for an insurance underwriting offer for the motor vehicle driver. A performance profile is generated for the motor vehicle driver based on the historical risk event data and telematic data. The performance profile is provided to a plurality of motor vehicle insurance providers. An insurance underwriting offer is received from at least one of the motor vehicle insurance providers. The insurance underwriting offer is sent in response to the received request.

An insurance exchange device includes a processor coupled to a memory and configured to execute programmed instructions stored in the memory including obtaining at least historical risk event data and telematic data for a motor vehicle driver in response to a received request for an insurance underwriting offer for the motor vehicle driver. A performance profile is generated for the motor vehicle driver based on the historical risk event data and telematic data. The performance profile is provided to a plurality of motor vehicle insurance providers. An insurance underwriting offer is received from at least one of the motor vehicle insurance providers. The insurance underwriting offer is sent in response to the received request.

This technology provides a number of advantages including methods, non-transitory computer readable media, and devices that facilitate a motor vehicle insurance exchange or marketplace for prospective customers of motor vehicle insurance. With this technology, a comprehensive profile of data useful for making underwriting decisions and determining rates is collected by a third party intermediary insurance exchange device. Prospective customers advantageously interface with the insurance exchange device to submit a single request for underwriting offers and approval to release the associated collected data to insurance providers. Insurance providers then receive an increased amount of relevant data from which to make underwriting decisions and generate rates, which are provided to the requesting prospective customer for review and approval.

### BRIEF DESCRIPTION OF THE DRAWINGS

FIG. 1 is a block diagram of an exemplary network environment which incorporates an exemplary insurance exchange device coupled to customer computing devices, performance data source devices, and insurance provider devices;

FIG. 2 is a flowchart of an exemplary method for facilitating a motor vehicle insurance exchange; and

FIG. 3 is an exemplary table including exemplary historical risk events and telematic data and corresponding source of the historical risk events and telematic data.

### DETAILED DESCRIPTION

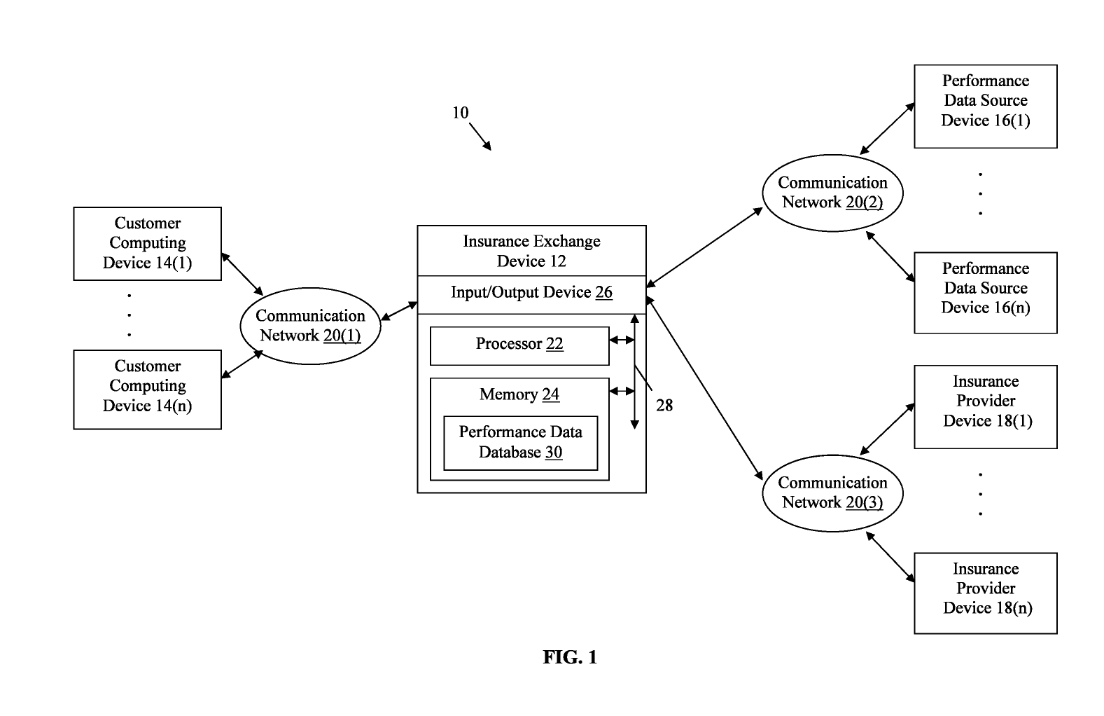

An exemplary network environment 10 with an insurance exchange device 12 coupled to customer computing devices 14(1)-14(n), performance data source devices 16(1)-16(n), and insurance provider devices 18(1)-18(n) by communication networks 20(1), 20(2), and 20(3) is illustrated in FIG. 1, although this network environment 10 can include other numbers and types of systems, devices, and elements in other configurations. While not shown, the network environment 10 also may include additional network components such as routers and switches which are well known to those of ordinary skill in the art and thus will not be described here. This technology provides a number of advantages including methods, non-transitory computer readable media, and devices that facilitate a motor vehicle insurance exchange allowing prospective customers to efficiently obtain underwriting rates and insurance providers to make more effective underwriting decisions based on a comprehensive profile of data regarding the prospective customers.

The insurance exchange device 12 includes a processor 22, a memory 24, and an input/output device 26, which are coupled together by a bus 28 or other link, although other numbers and types of systems, devices, components, and elements in other configurations and locations can also be used. The processor 22 in the insurance exchange device 12 executes a program of stored instructions for one or more aspects of the present technology, as described and illustrated by way of the examples herein, although other types and numbers of processing devices and configurable hardware logic could be used and the processor 22 could execute other numbers and types of programmed instructions.

The memory 24 in the insurance exchange device 12 stores these programmed instructions for one or more aspects of the present technology as described and illustrated herein, although some or all of the programmed instructions could be stored and executed elsewhere. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the processor 22, can be used for the memory 24.

In this example, the memory 24 includes a performance data database 30, although the memory can include other types of data and programmed instructions. The performance data database 30 is a repository for historical risk event and telematic data obtained from the performance data source devices 16(1)-16(n) and associated with a motor vehicle driver, as described and illustrated in more detail later. In other examples, the memory 24 can store other information in other formats and the information stored in the performance data database 30 can be stored elsewhere.

The input/output device 26 in the insurance exchange device 12 is used to operatively couple and communicate between the insurance exchange device 12, the customer computing devices 14(1)-14(n), the performance data source devices 16(1)-16(n), and the insurance provider devices 18(1)-18(n) via the communication networks 20(1)-20(3), although other types and numbers of connections and configurations can also be used. By way of example only, the communication networks 20(1)-20(3) can include one or more local area networks or wide area networks, for example, and can use TCP/IP over Ethernet and industry-standard protocols, including hypertext transfer protocol (HTTP) and secure HTTP (HTTPS), although other types and numbers of communication networks, such as a direct connection, modems and phone lines, e-mail, and wireless and hardwire communication technology, each having their own communications protocols, can also be used.

The customer computing devices 14(1)-14(n) in this example each include a processor, a memory, an input/output device, an input device, and a display device, which are coupled together by a bus or other link. The customer computing devices 14(1)-14(n) also can have other numbers and types of systems, devices, components, and elements in other configurations and locations. The customer computing devices 14(1)-14(n) can be mobile computing devices, smartphones, tablets, laptops, desktop computers, or any combination thereof. Motor vehicle drivers and representative of fleet operators, for example, can use the customer computing devices 14(1)-14(n) to interface with the insurance exchange device 12 to request insurance underwriting offers from insurance providers users of the insurance provider devices 18(1)-18(n), as described and illustrated in more detail later.

The performance data source devices 16(1)-16(n) in this example each include a processor, a memory, and an input/output device, which are coupled together by a bus or other link. The performance data source devices 16(1)-16(n) can also have other numbers and types of systems, devices, components, and elements in other configurations and locations. In some examples, the performance data source devices 16(1)-16(n) include one or more server computing devices hosted by providers of performance data and/or one or more telematics devices, as described and illustrated in more detail later.

The insurance provider devices 18(1)-18((n) in this example each include a processor, a memory, an input/output device, an input device, and a display device, which are coupled together by a bus or other link. The insurance provider devices 18(1)-18(n) can also have other numbers and types of systems, devices, components, and elements in other configurations and locations. The insurance provider devices 18(1)-18(n) can be mobile computing devices, smartphones, tablets, laptops, desktop computers, or any combination thereof. Representatives of an insurance provider, for example, can use the insurance provider devices 18(1)-18(n) to interface with the insurance exchange device to receive requests for underwriting offers from users of the customer computing devices 14(1)-14(n) and submit underwriting offers in response to the requests, as described and illustrated in more detail later.

Although examples of the insurance exchange device 12, customer computing devices 14(1)-14(n), performance data source devices 16(1)-16(n), and insurance provider devices 18(1)-18(n), which are coupled together via the communication networks 20(1-20(3) are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s). Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, or combinations thereof.

The examples may also be embodied as a non-transitory computer readable medium having programmed instructions stored thereon for one or more aspects of the present technology as described and illustrated by way of the examples herein. The programmed instructions, when executed by a processor, cause the processor to carry out the steps necessary to implement one or more methods of the examples, as described and illustrated herein.

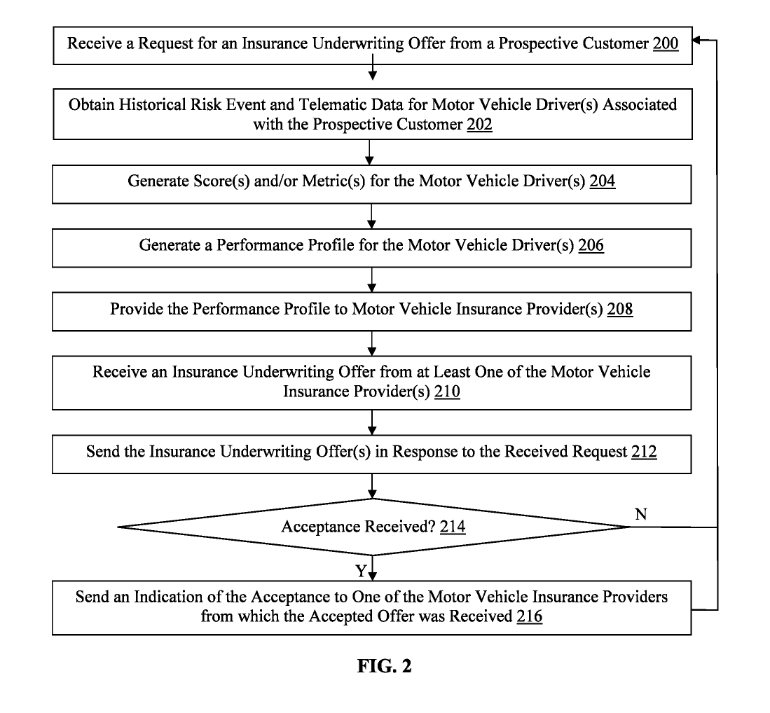

Exemplary methods and devices for facilitating a motor vehicle insurance exchange will now be described with reference to FIGS. 1-3. Referring more specifically to FIG. 2, in step 200 the insurance exchange device 12 receives a request for insurance underwriting offers from a user of one of the customer computing devices 14(1)-14(n). The user can be a prospective customer such as a motor vehicle driver or a representative of a fleet operator associated with a plurality of motor vehicle drivers, for example, although other types of users can also submit requests in step 200.

Optionally, the insurance exchange device 12 is configured to register users and store the registration information in the memory 24. In this example, the user of the one of the customer computing devices 14(1)-14(n) submits a login that is authenticated by the insurance exchange device 12 prior to submitting the request in step 200. During the motor vehicle insurance customer registration process, or along with the request for unregistered users, the user of the one of the customer computing devices 14(1)-14(n) can submit demographic information of the one or more motor vehicle drivers associated with the user, which is stored by the insurance exchange device 12 in the memory 24, for example, and used as described and illustrated in more detail later.

Accordingly, in this example, the user of the one of the customer computing devices 14(1)-14(n) is configured to interface with the insurance exchange device 12, such as by using web page(s) provided by the insurance exchange device 12, although other manners for interfacing could be used. For example, the web page(s) can include an insurance underwriting offer request form web page including various parameters (e.g. coverage options) that may be common parameters required by insurance providers in order to generate an insurance underwriting offer and associated insurance rate. Optionally, the user of the one of the customer computing devices 14(1)-14(n) can further submit, using the insurance underwriting offer request form web page, an explicit approval for the insurance exchange device 12 to obtain from the performance data source devices 16(1)-16(n), and/or send to users of the insurance provider devices 18(1)-18(n), performance data on behalf of the motor vehicle driver(s) associated with the user, as described and illustrated in more detail later.

Optionally, the user of the one of the customer computing devices 14(1)-14(n) can further submit, using the insurance underwriting offer request form web page, a selection of the insurance provider(s) from which it is interested in receiving an insurance underwriting offer. In this example, the insurance providers selectable by the user are each associated with one of the insurance provider devices 18(1)-18(n) and can be registered as participants in the insurance exchange by users of the insurance provider devices 18(1)-18(n). The insurance providers can be insurance companies, insurance brokers, or any other intermediary or underwriter capable of providing insurance underwriting offers to prospective consumer and/or commercial customers.

During the insurance provider registration process, a user of one of the insurance provider devices 18(1)-18(n) can submit to the insurance exchange device 12 any parameters required for the insurance provider associated with the user to make an underwriting offer. The submitted parameters can then be associated with input fields displayed to users of the customer computing devices 14(1)-14(n) as part of the underwriting offer request form web page, along with input fields associated with the common parameters as described and illustrated earlier, for example. Other methods of determining the parameters required by insurance providers, generating an insurance underwriting request form web page, and obtaining parameters from prospective customers can also be used.

In step 202, the insurance exchange device 12 obtains performance data including at least a historical risk event and telematic data from one or more of the performance data source devices 16(1)-16(n). In this example, the performance data is obtained from the performance data source devices 16(1)-16(n) using the input/output device 26 and communication network 20(2). The obtained performance data is associated with the motor vehicle driver(s) associated with the user of the one of the customer computing devices 14(1)-14(n) that submitted the request received in step 200. The one or more motor vehicle drivers associated with the user can be determined by the insurance exchange device 12 based on the demographic information previously obtained from the user of the one of the customer computing devices 14(1)-14(n) and stored in the memory 24 during the customer registration process, although other methods of identifying the one or more motor vehicle drivers can also be used.

While in this example, the performance data is obtained by the insurance exchange device 12 subsequent to receiving the request in step 200, in other examples, the insurance exchange device 12 periodically obtains and updates previously obtained performance data for motor vehicle driver(s) associated with current or prospective users of the customer computing devices 14(1)-14(n). The performance data can also be obtained at other times and in other manners. The obtained performance data can be stored in the performance data database 30 as associated with the corresponding motor vehicle driver(s) and/or an indication of the fleet operator associated with the corresponding motor vehicle drivers, for example.

In this example, the performance data includes at least incident, collision, and violation historical risk event data and vehicle operation information obtained from telematics device(s), although other types and numbers of performance data can also be obtained in step 202. Accordingly, the performance data source devices 16(1)-16(n) in this example can include server computing device(s) hosted by a government agency, such as a state department of motor vehicles and/or the Federal Motor Carrier Safety Administration, which are configured to store and selectively provide motor vehicle records and/or violations (e.g., road side inspection violations) for the motor vehicle driver(s).

The performance data source devices 16(1)-16(n) can also include one or more server computing devices associated with an insurance company, broker, and/or leasing company, for example, which are configured to store and selectively provide claim information including incident and collision data for the one or more motor vehicle drivers. In yet other examples, the performance data source devices 16(1)-16(n) can include one or more server computing devices maintained by a fleet operator and configured to store and selective provide performance data including historical risk events such as company policy violations and complaints submitted by third parties, for example. Other performance data associated with other historical risk events can also be obtained by the insurance exchange device 12.

Additionally, the performance data source devices 16(1)-16(n) in this example include a telematics devices attached to a computing device in a motor vehicle associated with one of the motor vehicle drivers, and/or one of the server computing devices which stores performance data output by the telematics device. Each of the telematics devices are configured to transmit, and/or the one or more server computing devices are configured to store and selectively provide, information regarding the operation of the one or more motor vehicles associated with the one or more motor vehicle drivers.

Exemplary performance data obtained from one or more of the performance data source devices 16(1)-16(n) associated with telematics devices includes speeding and braking events, for example. In other examples, the telematics performance data can include acceleration, idling, miles per gallon, steering, reversing, and/or miles driven data, for example, although any other telematics data can also be obtained by the insurance exchange device 12. Additionally, the performance data source devices 16(1)-16(n) can also include other types and numbers of devices configured to store and/or selectively provide other performance data to the insurance exchange device 12 using the communication network 20(2).

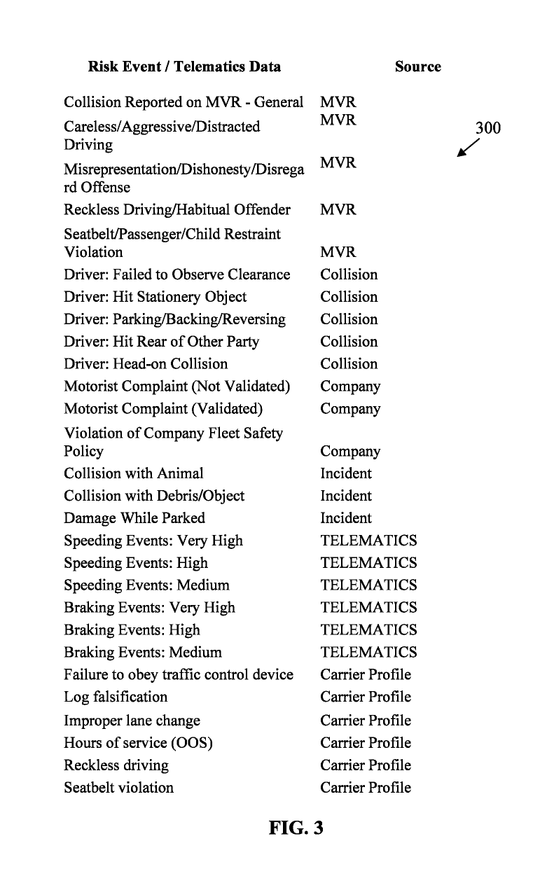

Referring to FIG. 3, an exemplary table 300 including exemplary historical risk events and telematic data and corresponding source of the events and data is illustrated. In this example, the table 300 includes exemplary historical risk events such as “Reckless Driving/Habitual Offender,” “Driver: Head-on Collision,” “Motorist Complaint (Validated),” “Damage While Parked,” “Speeding Events: Very High,” and “Improper lane change,” for example, although any other risk events can be included in the performance data obtained by the insurance exchange device 12 in step 202.

In this example, “Collision Reported on MVR—General” is a risk event that can be identified from motor vehicle record (MVR) performance data provided by one of the performance data source devices 16(1)-16(n) associated with a state department of motor vehicles. Additionally, “Driver: Head-on Collision” is a risk event that can be identified from collision or claims data provided by one of the performance data source devices 16(1)-16(n) associated with a current or past insurance provider. Accordingly, by obtaining performance data from multiple sources, including a state department of motor vehicles and an insurance provider in this example, more collisions associated with the motor vehicle driver(s) can be identified.

Additionally, by obtaining at least incident, collision, and violation historical risk event data and vehicle operation telematic data for the one or more motor vehicle drivers, the insurance exchange device 12 can utilize a relatively comprehensive profile of performance data in order to generate a performance profile for the motor vehicle drivers that is provided to insurance providers, as described and illustrated in more detail later. Additionally, insurance providers can make better and more informed underwriting decisions and generate more favorable underwriting rates to include in underwriting offers sent to prospective customers.

Referring back to FIG. 2, in step 204 the insurance exchange device 12 optionally generates one or more scores and/or metrics for each of the one or more motor vehicle drivers individually and/or collectively in the case of a fleet operator user of the one of the customer computing devices 14(1)-14(n). The scores generated for each of the motor vehicle drivers can indicate a relative risk level of the drivers. In one example, a score can be assigned for one or more of the risk events and/or telematic events identified in the telematic data obtained in step 202. The score for each of the risk and/or telematic events can be based on a severity of the event and/or a time period likely required to change the behavior of the motor vehicle driver such that the risk of the event occurring in the future is minimized, for example.

Optionally, the scores for each of the risk and/or telematic events can be reduced based on the age of the associated events. Accordingly, events occurring further in the past can be assigned a lower score than events occurring relatively recently and of otherwise corresponding severity. Based on the score for each of the risk and/or telematic events, an overall score can be generated for each of the one or more motor vehicle drivers. Other methods of generating risk event, telematic event, and/or overall scores for the one or more motor vehicle drivers can also be used.

The one or more scores or metrics generated by the insurance exchange device 12 in step 204 can include collisions, license violations, telematic events, or risk events per million miles or per the trailing three or five year period, for example, although any other score or metric can also be used. Optionally, the scores and/or metrics generated by the insurance exchange device 12 in step 204 can be stored in the memory 24, such as in the performance data database 30, for example, although the scores and/or metrics can also be stored elsewhere.

In step 206, the insurance exchange device 12 generates a performance profile for each of the motor vehicle drivers associated with the user of the one of the customer computing devices 14(1)-14(n) that submitted the request received in step 200. The performance profile can include the obtained historical risk event and telematic data in a raw or processed format. For example, the performance profile can include an indication of the type and number of historical risk events and/or telematic events. In another example, the information included in the performance profile can be processed to aggregate the information, generates averages for a plurality of motor vehicle drivers, and/or remove any personally identifiable information, for example. Optionally, the performance profile also includes the scores and/or metrics generated in step 204. Other methods of presenting at least a portion of the information obtained in step 202 as a performance profile can also be used by the insurance exchange device 12.

In step 208, the insurance exchange device 12 provides the generated performance profile to a plurality of motor vehicle insurance providers by sending the performance profile to users of at least a subset of the insurance provider devices 18(1)-18(n) using the input/output device 26 and communication network 20(3). In one example, the performance profile can be sent to insurance providers submitted by the user of the one of the customer computing devices 14(1)-14(n) using the insurance underwriting offer request form web page and received in step 200. In another example, the performance profile can be sent to a default set of insurance providers as established by an administrator of the insurance exchange device 12.

In yet another example, users of one or more of the insurance provider devices 16(1)-16(n) can input filters during the insurance provider registration process described and illustrated earlier. The filters can be associated with the content of the request received in step 200 and/or with portions of the information included in the performance profile, for example. Accordingly, the filters can be used by the insurance exchange device 12 to direct the performance profile to a subset of insurance providers that may be interested in providing an insurance underwriting offer to the prospective customer. For example, some insurance providers may only be interested in providing an insurance underwriting offer to prospective fleet operator customers. In another example, some insurance providers may only be interested in providing an insurance underwriting offer to consumer customers that have not had any violations in the trailing three year time period. Other types and numbers of filters can also be used.

The insurance exchange device 12 can provide the performance profile in step 208 by generating a performance profile web page including the performance profile and sending a link to the web page to each user of the subset of insurance provider devices 18(1)-18(n). The link can be sent by e-mail, for example, using contact information received and stored by the insurance exchange device 12 during the insurance provider registration process. In another example, the performance profile web page can be provided to the subset of insurance provider devices 18(1)-18(n) in response to a request received from a user one of the subset of insurance provider devices 18(1)-18(n), for example.

In yet another example, the performance profile can be sent to a user of one of the subset of insurance provider device(s) 18(1)-18(n) as a Portable Data Format (PDF) document or a document of another format or file type, for example. Other methods of providing the performance profile can also be used and different methods of providing the performance profile can be used for different ones of the insurance providers based on preferences received and stored by the insurance exchange device 12 during the insurance provider registration process, for example.

In step 210, the insurance exchange device 12 receives an insurance underwriting offer from a user of at least one of the subset of insurance provider devices 18(1)-18(n) using the input/output device 16 and the communication network 20(3), for example. In one example, a user of one of the subset of insurance provider devices 18(1)-18(n) can submit an underwriting offer using a response form web page provided to the one of the subset of insurance provider devices 18(1)-18(n) by the insurance exchange device 12. In another example, one or more insurance underwriting offers are received by the insurance exchange device 12 as PDF documents or documents of another format or file type, for example, that are uploaded to the insurance exchange device 12 by a user of one of the subset of insurance provider devices 18(1)-18(n). Other methods of receiving insurance underwriting offer(s) in response to the provided performance profile can also be used.

In step 212, the insurance exchange device 12 sends the one or more received insurance underwriting offers to the one of the customer computing devices 14(1)-14(n) from which the request was received by the insurance exchange device 12 in step 200. The insurance exchange device 12 can send the one or more underwriting offers by generating an offer web page including the underwriting offers and sending a link to the web page to the user of the one of the customer computing devices 14(1)-14(n). The link can be sent by e-mail, for example, using contact information received and stored by the insurance exchange device 12 during the customer registration process. In another example, the generated web page can be sent to the user of the one of the customer computing devices 14(1)-14(n) in response to a request received from the user. In yet another example, the underwriting offers can be sent to the user of the one of the customer computing devices 14(1)-14(n) as one or more PDF documents or documents of another format or file type, for example.

Each of the underwriting offers can be sent in step 212 substantially upon receipt in step 210 or, alternatively, the received underwriting offers can all be sent at one time. In examples in which the underwriting offers are sent at one time, the insurance exchange device 12 can be configured to send the offers after a time period subsequent to receipt of the request in step 200 has elapsed. The time period can be a default time period established by an administrator of the insurance exchange device 12 or submitted by the user of the one of the customer computing devices 14(1)-14(n) along with the request in step 200.

Optionally, the time period that the request received in step 200 will remain open can be provided to the users of the subset of the insurance provider devices 18(1)-18(n) along with the performance profile in step 208. Other methods of sending the underwriting offers can also be used and different methods of sending the underwriting offers can be used for different prospective customers based on preferences received and stored by the insurance exchange device 12 during the customer registration process, for example.

In step 214, the insurance exchange device 12 determines whether an acceptance of one of the insurance underwriting offer(s) is received from the user of the one of the customer computing devices 14(1)-14(n). In one example, the offer web page sent to the user of the one of the customer computing devices 14(1)-14(n) can include a user input element configured to communicate an acceptance, and an indication of which one of the offers is accepted, to the insurance exchange device 12 when selected by the user. Other methods of receiving an acceptance of one of the offers sent to the user of the one of the customer computing devices 14(1)-14(n) can also be used. If the insurance exchange device 12 determines that an acceptance of an acceptance of one of the insurance underwriting offer(s) is received from the user of the one of the customer computing devices 14(1)-14(n), then the Yes branch is taken to step 216.

In step 216, the insurance exchange device 12 sends an indication of the acceptance of the one of the underwriting offers to the user of one of the insurance provider devices 18(1)-18(n) that submitted the one of the underwriting offers received in step 210 and sent to the prospective customer in step 212. The insurance exchange device 12 can send an indication of the acceptance by generating an acceptance web page including an indication of the one of the underwriting offers that was accepted, such as a unique identifier associated with the offer by the user of the one of the insurance provider devices 18(1)-18(n) and received by the insurance exchange device 12 along with the one of the underwriting offers in step 210.

In one example, the insurance exchange device can send a link to the acceptance web page to the user of the one of the insurance provider devices 18(1)-18(n) from which the accepted underwriting offer was received by the insurance exchange device 12 in step 210. The link can be sent by e-mail, for example, using contact information received and stored by the insurance exchange device 12 during the insurance provider registration process. In another example, the acceptance web page can be sent to the user of the one of the insurance provider devices 18(1)-18(n) in response to a request received from the user. Other methods of sending the indication of the acceptance of the one of the underwriting offers can also be used.

Optionally, contact information for the prospective customer, that may have been included in personally identifiable information removed in step 208, can be sent by the insurance exchange device 12 along with the indication of the acceptance in step 216. Accordingly, the user of the one of the insurance provider devices 18(1)-18(n) from which the accepted underwriting offer was received by the insurance exchange device 12 in step 210 can use the contact information to communicate directly with the prospective customer for any additional documentation (e.g., a signed agreement to provide motor vehicle insurance and/or insurance cards) required to consummate a contract for the motor vehicle insurance. In other examples, the insurance exchange device 12 can facilitate receiving and/or sending any additional documentation required to consummate a contract from and/or to the user of the one of the insurance provider devices 18(1)-18(n) and/or the user of the one of the customer computing devices 14(1)-14(n), although other methods of facilitating the consummation of a contract between the prospective customer and the insurance provider can also be used.

Referring back to step 214, if the insurance exchange device 12 determines that an acceptance of one of the insurance underwriting offer(s) is not received from the user of the one of the customer computing devices 14(1)-14(n), then the No branch is taken back to step 200 and another request is received from the same or another user of one of the customer computing devices 14(1)-14(n). In this example, any of steps 200-216 can be performed by the insurance exchange device 12 in parallel for various users of the customer computing devices 14(1)-14(n).

By this technology, an intermediary insurance exchange device advantageously facilitates a motor vehicle insurance marketplace for prospective customers of motor vehicle insurance and insurance providers. With this technology, prospective customers of motor vehicle insurance can initiate the communication of a comprehensive profile of performance data including historical risk events, including incidents, collisions, and violations, and telematic data regarding vehicle operation for one or more associated motor vehicle drivers to insurance providers. In response, insurance providers can utilize the comprehensive profile of performance data to make more informed underwriting decisions and offer relatively favorable underwriting rates. As a result, insurance providers can reduce the risk inherent in providing motor vehicle insurance and prospective customers can receive competitive underwriting rates thereby lowering their insurance costs.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method for facilitating a motor vehicle insurance exchange, the method comprising:
obtaining, with an insurance exchange device, at least historical risk event data and telematic data for a motor vehicle driver in response to a received request for an insurance underwriting offer for the motor vehicle driver, wherein at least a portion of the historical risk event data is obtained from a plurality of third parties other than the motor vehicle driver, the third parties comprising at least one government entity and at least one of a current or past insurance provider or broker for the motor vehicle driver or a leasing company associated with the motor vehicle driver;
generating, with the insurance exchange device, a performance profile for the motor vehicle driver, wherein the performance profile comprises the historical risk event data and telematic data;
requesting, with the insurance exchange device, an insurance underwriting offer for the motor vehicle driver from a plurality of motor vehicle insurance providers, the requesting comprising providing the performance profile comprising the historical risk event data and telematic data for the motor vehicle driver to the plurality of motor vehicle insurance providers;
receiving, with the insurance exchange device, an insurance underwriting offer from at least one of the plurality of motor vehicle insurance providers; and
sending, with the insurance exchange device, the insurance underwriting offer in response to the received request.

2. The method of claim 1, wherein:
the at least one government entity comprises a state department of motor vehicles or a federal government agency; and
the historical risk event data comprises incident, collision, or violation data associated with the motor vehicle driver.

3. The method of claim 1, further comprising generating, with the insurance exchange device, an overall score for the motor vehicle driver based on the historical risk event data, wherein the performance profile further includes the overall score.

4. The method of claim 1, further comprising generating, with the insurance exchange device, one or more metrics based on the performance data, wherein the driver performance profile further includes the one or more metrics.

5. The method of claim 1, wherein:
the request is received from a computing device associated with a representative of a fleet vehicle operator;
the motor vehicle driver comprises a plurality of motor vehicle drivers associated with the fleet vehicle operator; and
the sending further comprising sending the insurance underwriting offer to the computing device associated with the representative of the fleet vehicle operator.

6. The method of claim 1, further comprising:
receiving, with the insurance exchange device, an acceptance of the insurance underwriting offer from one of the motor vehicle insurance providers; and
providing, with the insurance exchange device, an indication of the acceptance to the one of the motor vehicle insurance providers.

7. The method of claim 1, wherein the generating the performance profile for the one or more motor vehicle drivers further comprises removing any personally identifiable information from the historical risk event data and telematic data.

8. A non-transitory computer readable medium having stored thereon instructions for facilitating a motor vehicle insurance exchange comprising machine executable code which when executed by a processor, causes the processor to perform steps comprising:
obtaining at least historical risk event data and telematic data for a motor vehicle driver in response to a received request for an insurance underwriting offer for the motor vehicle driver, wherein at least a portion of the historical risk event data is obtained from a plurality of third parties other than the motor vehicle driver, the third parties comprising at least one government entity and at least one of a current or past insurance provider or broker for the motor vehicle driver or a leasing company associated with the motor vehicle driver;
generating a performance profile for the motor vehicle driver, wherein the performance profile comprises the historical risk event data and telematic data;
requesting an insurance underwriting offer for the motor vehicle driver from a plurality of motor vehicle insurance providers, the requesting comprising providing the performance profile comprising the historical risk event data and telematic data for the motor vehicle driver to the plurality of motor vehicle insurance providers;
receiving an insurance underwriting offer from at least one of the plurality of motor vehicle insurance providers; and
sending the insurance underwriting offer in response to the received request.

9. The medium of claim 8, wherein:
the at least one government entity comprises a state department of motor vehicles or a federal government agency; and
the historical risk event data comprises incident, collision, or violation data associated with the motor vehicle driver.

10. The medium of claim 8, further having stored thereon instructions that when executed by the processor cause the processor to perform steps further comprising generating an overall score for the motor vehicle driver based on the historical risk event data, wherein the performance profile further includes each of the overall scores.

11. The medium of claim 8, further having stored thereon instructions that when executed by the processor cause the processor to perform steps further comprising generating one or more metrics based on the performance data, wherein the driver performance profile further includes the one or more metrics.

12. The medium of claim 8, wherein:
the request is received from a computing device associated with a representative of a fleet vehicle operator;
the motor vehicle driver comprises a plurality of motor vehicle drivers associated with the fleet vehicle operator; and
the sending further comprising sending the insurance underwriting offer to the computing device associated with the representative of the fleet vehicle operator.

13. The medium of claim 8, further having stored thereon instructions that when executed by the processor cause the processor to perform steps further comprising:
receiving an acceptance of the insurance underwriting offer from one of the motor vehicle insurance providers; and
providing an indication of the acceptance to the one of the motor vehicle insurance providers.

14. The medium of claim 8, wherein the generating the performance profile for the one or more motor vehicle drivers further comprises removing any personally identifiable information from the historical risk event data and telematic data.

15. An insurance exchange device, comprising:
a processor coupled to a memory and configured to execute programmed instructions stored in the memory comprising:
obtaining at least historical risk event data and telematic data for a motor vehicle driver in response to a received request for an insurance underwriting offer for the motor vehicle driver, wherein at least a portion of the historical risk event data is obtained from a plurality of third parties other than the motor vehicle driver, the third parties comprising at least one government entity and at least one of a current or past insurance provider or broker for the motor vehicle driver or a leasing company associated with the motor vehicle driver;
generating a performance profile for the motor vehicle driver, wherein the performance profile comprises the historical risk event data and telematic data;
requesting an insurance underwriting offer for the motor vehicle driver from a plurality of motor vehicle insurance providers, the requesting comprising providing the performance profile comprising the historical risk event data and telematic data for the motor vehicle driver to the plurality of motor vehicle insurance providers;
receiving an insurance underwriting offer from at least one of the plurality of motor vehicle insurance providers; and
sending the insurance underwriting offer in response to the received request.

16. The device of claim 15, wherein:
the at least one government entity comprises a state department of motor vehicles or a federal government agency; and
the historical risk event data comprises incident, collision, or violation data associated with the motor vehicle driver.

17. The device of claim 15, wherein the processor is further configured to execute programmed instructions stored in the memory further comprising generating an overall score for the motor vehicle driver based on the historical risk event data, wherein the performance profile further includes each of the overall scores.

18. The device of claim 15, wherein the processor is further configured to execute programmed instructions stored in the memory further comprising generating one or more metrics based on the performance data, wherein the driver performance profile further includes the one or more metrics.

19. The device of claim 15, wherein:
the request is received from a computing device associated with a representative of a fleet vehicle operator;
the motor vehicle driver comprises a plurality of motor vehicle drivers associated with the fleet vehicle operator; and
the sending further comprising sending the insurance underwriting offer to the computing device associated with the representative of the fleet vehicle operator.

20. The device of claim 15, wherein the processor is further configured to execute programmed instructions stored in the memory further comprising:
receiving an acceptance of the insurance underwriting offer from one of the motor vehicle insurance providers; and
providing an indication of the acceptance to the one of the motor vehicle insurance providers.

21. The device of claim 15, wherein the generating the performance profile for the one or more motor vehicle drivers further comprises removing any personally identifiable information from the historical risk event data and telematic data.
